(19) United States
(12) Patent Application Publication
(10) Pub. No.: US 2018/0037486 A1
(43) Pub. Date: Feb. 8, 2018

(54) GLASS HOUSING, ELECTRONIC DEVICE HAVING THE SAME, MANUFACTURING APPARATUS AND METHOD THEREOF

(71) Applicants: SHENZHEN O-FILM TECH. CO., LTD., Shenzhen (CN); NANCHANG O-FILM OPTICAL TECHNOLOGY CO., LTD., Nanchang (CN)

(72) Inventors: Wei LIU, Nanchang (CN); Genchu TANG, Nanchang (CN); Bin TANG, Nanchang (CN)

(73) Assignees: SHENZHEN O-FILM TECH. CO., LTD., Shenzhen (CN); NANCHANG O-FILM OPTICAL TECHNOLOGY CO., LTD., Nanchang (CN)

(21) Appl. No.: 15/593,203

(22) Filed: May 11, 2017

(30) Foreign Application Priority Data
Aug. 3, 2016 (CN) 201610628997.4

(51) Int. Cl. C03B 11/00; C03C 21/00

(52) U.S. Cl. CPC C03B 11/005; C03C 21/002

(57) ABSTRACT

A glass housing includes an inner surface comprising a first flat portion and a first curved portion extending inward from a periphery of the first flat portion; an outer surface opposite to the inner surface, the outer surface comprising a second flat portion and a second curved portion extending inward from a periphery of the second flat portion; and a circumferential surface interconnecting the outer surface and the inner surface; wherein a distance between the inner surface and the outer surface ranges from 0.2 mm to 1.0 mm, the first and the second curved portions are arcuate surfaces having radii of curvature ranging from 5 mm to 50 mm.

### RELATED APPLICATIONS

This application claims priority under 35 U.S.C. § 119 to Chinese Patent Application No. 201610628997.4, filed on Aug. 3, 2016. The entire content of which is incorporated herein in its entirety.

### FIELD OF THE INVENTION

The present disclosure relates to electronic components, and more particularly relates to a glass housing, an electronic device, a manufacturing apparatus and method thereof.

### BACKGROUND OF THE INVENTION

With the popularity of electronic devices such as smart phones and smart watches which are provided with a touch screen, various manufacturers compete to release differentiated products to attract consumers. A highlight design emerging in current market is to design a housing of the electronic device to be a curved surface. The electronic device with the curved surface can better fit the hand of the user, thus improving the comfort of holding and handling. If the housing of the watch is designed to be a curved surface, it can also better fit the wrist of the user, thus improving the comfort of wearing. In addition, a displaying housing with the curved surface can make the displaying content have more stereoscopic effect, the appearance can thereby be improved. The electronic device becomes more popular using glass as a material of the housing due to its better texture. However, the glass housing of the electronic device, especially with the curved surface, is susceptible to cracking due to accidental fall.

### SUMMARY

Therefore, it is necessary to provide a glass housing, a manufacturing apparatus and method thereof, and an electronic device having the glass housing.

A glass housing includes an inner surface comprising a first flat portion and a first curved portion extending inward from a periphery of the first flat portion; an outer surface opposite to the inner surface, the outer surface comprising a second flat portion and a second curved portion extending inward from a periphery of the second flat portion; and a circumferential surface interconnecting the outer surface and the inner surface; wherein a distance between the inner surface and the outer surface ranges from 0.2 mm to 1.0 mm, the first and the second curved portions are arcuate surfaces having radii of curvature ranging from 5 mm to 50 mm.

An electronic device is provided including the aforementioned glass housing.

A manufacturing apparatus is also provided, which includes a chamber; and an upper die and a lower die disposed in the chamber; wherein the upper die comprises an upper flattened portion and an upper bent portion separated from the upper flattened portion, the lower die comprises a lower flattened portion and a lower bent portion separated from the lower flattened portion, the upper flattened portion and the lower flattened portion are configured to clamp a flat portion of a glass housing, the upper bent portion and the lower bent portion have the same arcuate curved surfaces, and the curved surfaces have radii of curvature ranging from 5 mm to 50 mm, the upper bent portion and the lower bent portion are configured to cooperatively extrude a curved portion of the glass housing.

A method of manufacturing the glass housing is also provided, which includes the following steps: cutting a glass mother substrate having a thickness of 0.2 mm to 1 mm into a plurality of glass sub-pieces with a predetermined dimension of the glass housing; CNC processing the glass sub-piece to make the glass sub-piece have a required shape of the glass housing; grinding the glass sub-piece to remove surface scratches and micro-cracks; clamping and positioning a middle portion of the glass sub-piece, then extruding and bending a periphery of the glass sub-piece to form an arcuate curved surface, and the curved surface has a radius of curvature ranging from 5 mm to 50 mm; and immersing the glass sub-piece into an alkali molten salt, thus forming a surface compressive stress layer on a surface of the glass sub-piece.

By the configuration of the structural parameters, the aforementioned glass housing can disperse the concentrated stress, enhance the integral strength and reduce the risk that cracks emerge easily by a slight collision due to the concentrated stress.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective view of a glass housing according to an embodiment;

FIG. 2 is a front view of the glass housing of FIG. 1;

FIG. 3 is a cross-sectional view take along line A-A of FIG. 2;

FIG. 4 is a side view of the glass housing of FIG. 2;

FIG. 5 is a perspective view of a glass housing according to another embodiment;

FIG. 6 is a front view of an electronic device according to an embodiment;

FIG. 7 is a flowchart of a method of manufacturing a glass housing according to an embodiment;

FIG. 8 is a schematic diagram showing glass sub-pieces in various stages of the method of FIG. 7; and

FIG. 9 is a schematic view of a manufacturing apparatus of the glass housing according to an embodiment.

### DETAILED DESCRIPTION OF THE EMBODIMENTS

Embodiments of the invention are described more fully hereinafter with reference to the accompanying drawings, in which preferred embodiments of the invention are shown. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

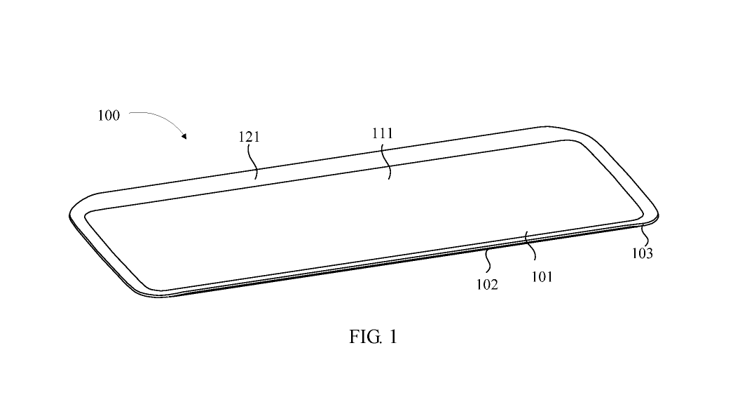

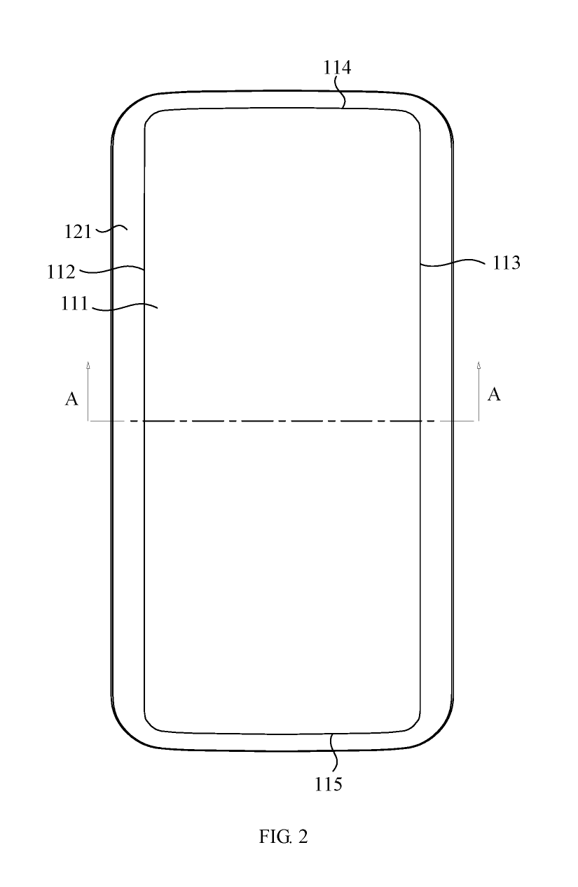

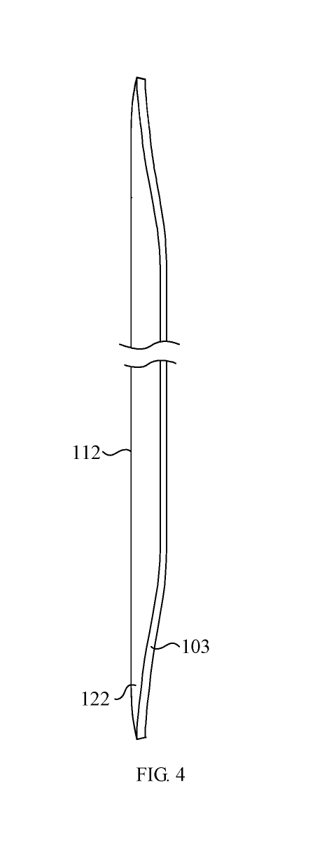

Referring to FIG. 1 to FIG. 4, a glass housing 100 according to an embodiment can be applied to electronic devices such as smart phones or the like, and it can serve as a displaying housing or a back cover plate of phones or the like.

The glass housing 100 includes an inner surface 101, an outer surface 102 opposite to the inner surface 101, and a circumferential surface 103 interconnecting the outer surface 102 and the inner surface 101.

The inner surface 101 includes a first flat portion 111 and a first curved portion 121 extending inward from a periphery of the first flat portion 111. The first curved portion 121 is an arcuate surface. The first curved portion 121 has a radius of curvature ranging from 1 mm to 50 mm. In one embodiment, the radius of curvature can range from 5 mm to 50 mm. In another embodiment, the radius of curvature can range from 5 mm to 20 mm. In yet another embodiment, the radius of curvature can range from 5 mm to 10 mm. The smaller the radius of curvature, the more curved the arcuate surface, such that the appearance of the formed glass housing 100 will have a more intense 3D stereoscopic effect.

In one embodiment, the first flat portion 111 is shaped as a rectangle having two opposite long sides 112, 113 and two opposite short sides 114, 115. In the illustrated embodiment, a radius of curvature of the first curved portion 121 connected to the long sides 112, 113 is not equal to a radius of curvature of the first curved portion 121 connected to the short sides 114, 115. Specifically, a radius of curvature of the first curved portion 121 connected to the long sides 112, 113 is less than a radius of curvature of the first curved portion 121 connected to the short sides 114, 115.

In the embodiment shown in FIG. 1 to FIG. 4, a radius of curvature of the first curved portion 121 connected to the long side 112 is equal to a radius of curvature of the first curved portion 121 connected to the long side 113. A radius of curvature of the first curved portion 121 connected to the short side 114 is equal to a radius of curvature of the first curved portion 121 connected to the short side 115.

The outer surface 102 also includes a second flat portion 112 and a second curved portion 122 extending inward from a periphery of the second flat portion 112. The second curved portion 122 and the first curved portion 121 are bent towards the same side, i.e. they are bent towards a side where the inner surface 101 is located. The second curved portion 122 is also an arcuate surface.

In one embodiment, the second flat portion 112 is aligned with the first flat portion 111, and the second flat portion 112 and the first flat portion 111 have the same size, such that when the glass housing 100 is placed on the horizontal plane, orthographic projections of the first flat portion 111 and the second flat portion 112 on the horizontal plane are completely coincided. The second curved portion 122 is aligned with the first curved portion 121, and the second curved portion 122 and the first curved portion 121 have the same size, such that when the glass housing 100 is placed on the horizontal plane, orthographic projections of the first curved portion 121 and the second curved portion 122 on the horizontal plane are completely coincided.

More specifically, radii of curvature of the second curved portion 122 and the first curved portion 121 are the same. In the illustrated embodiment, a distance between the inner surface 101 and the outer surface 102, i.e., a thickness of the glass housing 100 ranges from 0.2 mm to 1.0 mm. In one embodiment, the glass housing 100 has a thickness ranging from 0.5 mm to 0.7 mm. The glass housing 100 has a uniform thickness, such that the stress concentration can be eliminated and the integral strength of the glass housing 100 can be enhanced.

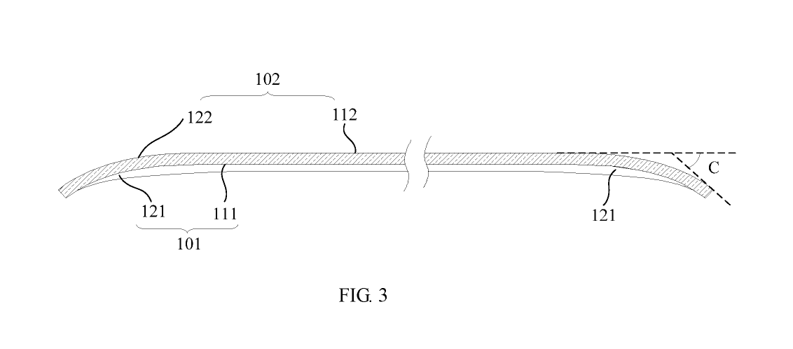

Referring to FIG. 3, an angle formed by the tangent of the most distal point of an arc where the second curved portion 122 is located and the extension line of the second flat portion 112 is defined as an angle C. The angle C ranges from 0° to 90°. In one embodiment, the angle C ranges from 0° to 45°. An angle C between the first curved portion 121 and the first flat portion 111 also has the same configuration.

In addition, a distance between the most distal point of an arc where the first curved portion 121 is located and the second flat portion 112, i.e., a height of the glass housing 100 ranges from 0.5 mm to 5.0 mm.

In some embodiments, an orthographic projection of the glass housing 100 on the horizontal plane is shaped as a rectangle, which has a length of 50 mm to 500 mm, and a width of 30 mm to 300 mm.

In some embodiments, at least one of the inner surface 101 and the outer surface 102 is provided with a decorative layer. The decorative layer can color the glass housing 100 to provide a more appealing appearance. The decorative layer can be formed on the inner surface 101 and/or the outer surface 102 by ink printing or adhering.

Specifically, when the decorative layer is formed by ink printing, the decorative layer has a thickness of 5 μm to 40 μm. When the decorative layer is formed by adhering a decorative film, the decorative film has a thickness of 10 μm to 125 μm. The decorative film can be formed by screen printing an explosion-proof membrane with a substrate, and it can also be formed by directly screen printing an adhesive without a substrate.

During a manufacturing process of the glass housing 100, at least one of the inner surface 101 and the outer surface 102 can be subjected to a strengthening treatment, such that the inner surface 101 and/or the outer surface 102 is provided with a surface compressive stress layer. In general, during the machining process of the glass, edges of the glass surface will inevitably generate micro-cracks, which can seriously reduce the strength of the glass. Although a size of the micro-crack can be decreased by physical machining processes such as polishing, further chemical strengthening treatment can achieve a better effect. For example, under a certain temperature, the glass can be immersed into a molten salt, the alkali metal ions in the glass and the alkali metal ions in the molten salt are interchanged by diffusion, therefore the surface compressive stress layer having a certain thickness is formed on the glass surface. Instead of an additional layered structure adhering to the glass surface, the surface compressive stress layer is a strengthening layer formed inwardly from the glass surface with a certain thickness. The micro-crack does not tend to extend due to the surface compressive stress layer, thereby enhancing the strength of the glass.

In some embodiments, by the strengthening treatment, the obtained surface compressive stress layer has a thickness of 50 μm to 100 μm. The surface compressive stress layer has a compressive stress of 200 MPa to 300 MPa. A central tensional stress between the inner surface 101 and the outer surface 102 is less than or equal to 100 MPa.

In some embodiments, the outer surface 102 is further attached with an anti-fingerprint layer. An initial water droplet angle of the anti-finger printer layer is greater than or equal to 110°.

By the configuration of the aforementioned structural parameters, the concentrated stress applied to the glass housing 100 can be dispersed, thus an integral strength of the glass housing 100 is enhanced. The risk that cracks emerge easily by a slight collision due to the concentrated stress is reduced.

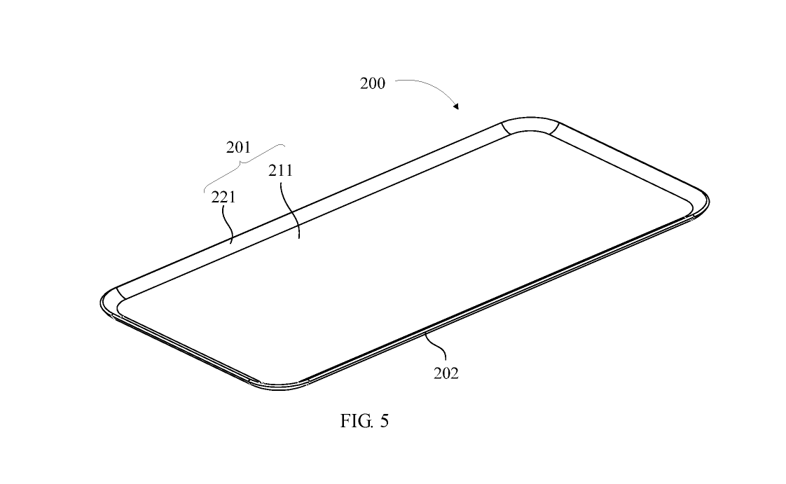

Referring to FIG. 5, a glass housing 200 according to another embodiment is similar to the glass housing 100 shown in FIG. 1 to FIG. 4. For example, the inner surface 201 also includes a first flat portion 211 and a first curved portion 221 extending inward from a periphery of the first flat portion 211. The first curved portion 221 is also an arcuate surface. The difference is that, a radius of curvature of the first curved portion 221 connected to each side of the first flat portion 211 is constant. The outer surface 202 has a configuration similar to the inner surface 201, and configurations not mentioned herein can be the same as those in the embodiment shown in FIG. 1 to FIG. 4, which will not be described again.

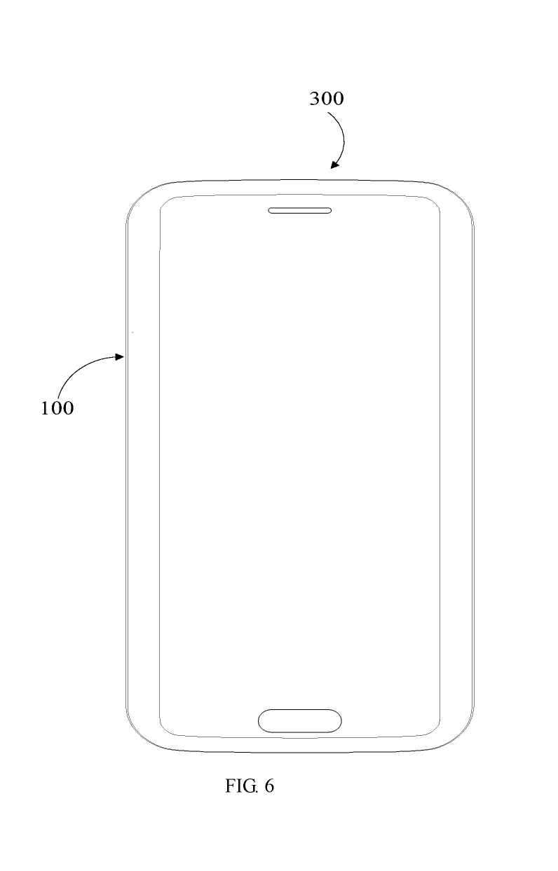

Referring to FIG. 6, an electronic device 300 according to an embodiment includes the aforementioned glass housing 100. In the illustrated embodiment, the electronic device 300 is a smart phone. In alternative embodiments, the electronic device 300 can also be a tablet computer or the like.

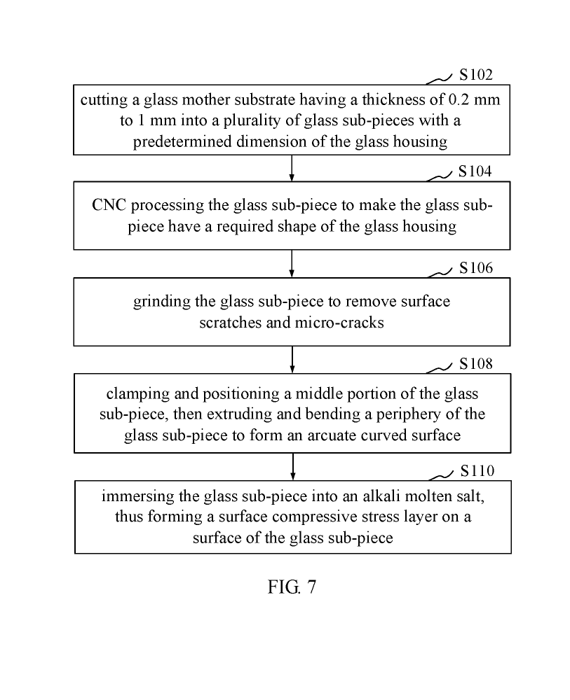

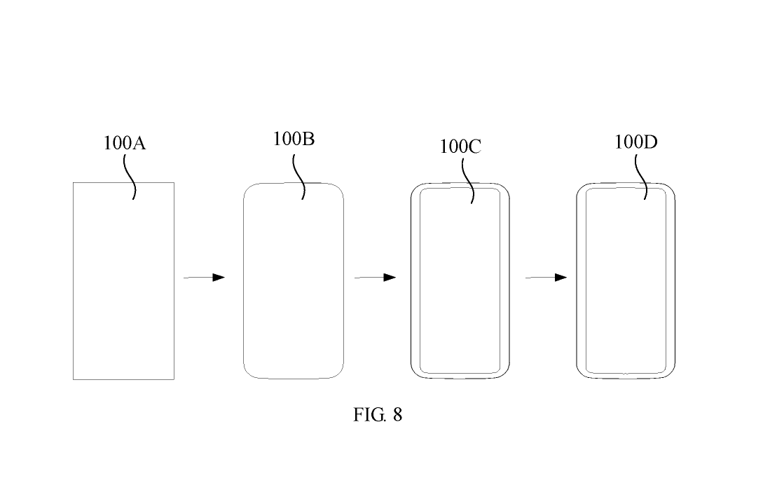

Referring to FIG. 7 and FIG. 8, a method of manufacturing the aforementioned glass housing 100 is further provided, which includes the following steps:

In step S102, a glass mother substrate having a thickness of 0.2 mm to 1 mm is cut into a plurality of glass sub-pieces 100A with a predetermined dimension of the glass housing 100. The size of the glass mother substrate can be determined according to efficiency and process needs. Cutting methods can be laser cutting or mechanical cutting.

In step S104, the glass sub-piece 100A is subjected to CNC processing to obtain a glass sub-piece 100B having a required shape of the glass housing 100.

In step S106, the glass sub-piece 100B is ground to remove surface scratches and micro-cracks. CNC processing may inevitably damage the processing surface of the glass sub-piece 100B and generate micro-cracks, some larger micro-cracks can be eliminated by grinding, such that they will not extend easily.

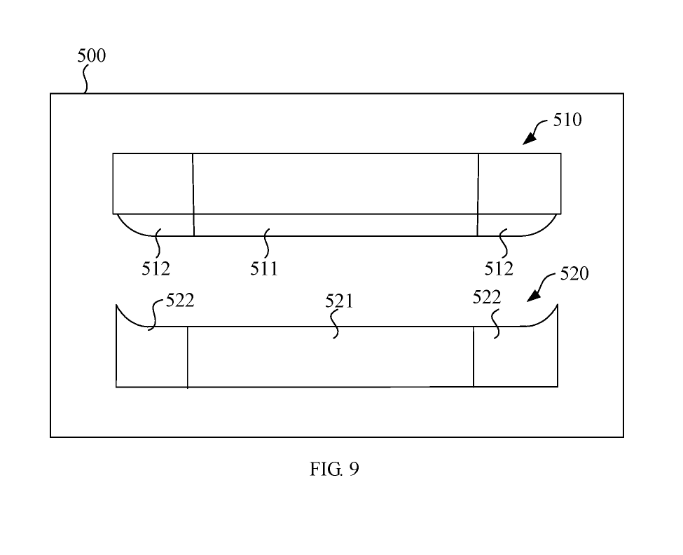

In step S108, a middle portion of the glass sub-piece 100B is clamped and positioned, and then a periphery of the glass sub-piece 100B is extruded and bent by a manufacturing apparatus shown in FIG. 9. During step S108, edges of the upper surface and the lower surface of the glass sub-piece 100C can form curved portions, while middle portions of the upper surface and the lower surface are still flat, thereby forming flat portions.

Specifically, the glass sub-piece 100B is heated to a temperature of 690±10° C. The glass sub-piece 100B is subjected to hot bending under a nitrogen atmosphere, the pressing pressure is 0.14±0.05 MPa, the pressing time is 2±0.5 min. At this moment, a glass sub-piece 100C is substantially formed, which has a flat portion and a curved portion located at a periphery of the flat portion.

Referring to FIG. 9, a manufacturing apparatus used in step S108 is provided. The manufacturing apparatus includes a chamber 500, and an upper die 510 and a lower die 520 located in the chamber 500.

During extruding and bending, it is necessary to heat the glass sub-piece 100B under a protective gas atmosphere. The chamber 500 can ensure a better heating performance while providing the protective gas atmosphere. For example, the chamber 500 can be filled with nitrogen. The upper die 510 and the lower die 520 can also be made of materials with high temperature resistance, for example, graphite materials or ceramic materials. In one embodiment, the upper die 510 can also be provided with a silicon rubber layer, such that risks that cracks emerge easily due to the extruding can be reduced.

The upper die 510 and the lower die 520 can move towards each other for bending and deforming the glass sub-piece 100B disposed between the upper die 510 and the lower die 520. Specifically, the upper die 510 includes an upper flattened portion 511 and an upper bent portion 512 separated from the upper flattened portion 511. The upper flattened portion 511 and the upper bent portion 512 are separately provided, therefore the upper flattened portion 511 and the upper bent portion 512 can be controlled separately and moved independently. Similarly, the lower die 520 includes a lower flattened portion 521 and a lower bent portion 522 separated from the lower flattened portion 521. Similarly, the lower flattened portion 521 and the lower bent portion 522 are separately provided, therefore the lower flattened portion 521 and the lower bent portion 522 can be controlled separately and moved independently. By separately providing the flattened portions 511, 521 and the bent portions 512, 522, the generation of micro-cracks due to the excessive integral stress of the glass is avoided, thereby improving the yield and the strength of glass products.

The upper flattened portion 511 and the lower flattened portion 521 are configured to clamp the flat portions 111, 112 of the glass housing 100. The upper bent portion 512 and the lower bent portion 522 have the same curved surfaces, and the curved surfaces have radii of curvature ranging from 1 mm to 50 mm. In one embodiment, the radii of curvature can range from 5 mm to 50 mm. In another embodiment, the radii of curvature can range from 5 mm to 20 mm. In yet another embodiment, the radii of curvature can range from 5 mm to 10 mm. The upper bent portion 512 and the lower bent portion 522 are configured to cooperatively extrude the curved portions 121, 122 of the glass housing 100.

When the glass sub-piece 100B is subjected to extruding and bending, the upper flattened portion 511 and the lower flattened portion 521 can be controlled to move towards each other, such that the upper flattened portion 511 and the lower flattened portion 521 can clamp and position the glass sub-piece 100B at a portion corresponds to the flat portions 111, 112 of the glass housing 100. After the glass sub-piece 100B is fixed and positioned, the upper bent portion 512 and the lower bent portion 522 are then moved towards each other, peripheries of the glass sub-piece 100B are then extruded. The upper bent portion 512 and the lower bent portion 522 have curved surfaces, such that peripheries of the glass sub-piece 100C are finally formed into the curved portions 121, 122 of the glass housing 100.

In some embodiments, the upper bend portion 512 includes a plurality of (e.g. two, three or four) upper bent sub-portions located around the upper flattened portion 511. The lower bent portion 522 includes a plurality of lower bent sub-portions located around the lower flattened portion 521. In alternative embodiments, the upper bent portion 512 can be integrally formed and shaped as a ring, which is disposed on the periphery of the upper flat portion 511. The lower bent portion 522 can also be integrally formed and shaped as a ring, which is disposed on the periphery of the lower flat portion 521.

In the illustrated embodiment, the upper bent portion 512 and/or the lower bent portion 522 are provided with a heating source to heat the periphery of the glass sub-piece 100B, while the upper flattened portion 511 and the lower flattened portion 521 are not provided with a heating source, because they only serves to clamp and position the glass sub-piece 100B. The heat can be conducted by conduction or radiation, for example, a corresponding portion of the glass sub-piece 100B is precisely radiated and heated by the heating source. By such configurations, the defect that the middle portion of the glass sub-piece 100B is easily deformed due to an integral hot-pressing can be overcome.

In alternative embodiments, both the middle portions and the peripheries of the glass sub-piece 100B can be heated by providing a heat source on the upper die 510 and the lower die 520, and the integral glass sub-piece 100B can be heated by precise radiation.

Referring to FIG. 7 again, in step S110, a strengthening treatment is performed. The glass sub-piece 100C is immersed into an alkali molten salt, such that metal ions within a depth range of 50 μm to 100 μm from the surface of the glass sub-piece 100C can be exchanged with metal ions in the alkali molten salt, thus forming a surface compressive stress layer on a glass sub-piece 100D. The surface compressive stress layer has a compressive stress of 200 MPa to 300 MPa by the strengthening treatment.

In some embodiments, the method further includes polishing the glass sub-piece 100C, prior to immersing the glass sub-piece 100C into the alkali molten salt. The polishing can reduce the micro-cracks generated at the edges in step S102, thereby enhancing the strength of the final product, making the final product less susceptible to cracking.

In some embodiments, the method further includes forming a decorative layer on a surface of the glass sub-piece 100D after the strengthening treatment. The decorative layer can color the glass housing 100 to provide a more appealing appearance. The decorative layer can also serve to shield the internal components of an electronic device. The decorative layer can be formed on the inner surface 101 and/or the outer surface 102 by ink printing or adhering.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present invention, but are not intended to limit the protection scope of the present invention. Any variation or replacement readily figured out by a person skilled in the art within the technical scope disclosed in the present invention shall all fall within the protection scope of the present invention. Therefore, the protection scope of the present invention shall be subject to the protection scope of the appended claims.

What is claimed is:

1. A glass housing, comprising:
an inner surface comprising a first flat portion and a first curved portion extending inward from a periphery of the first flat portion;
an outer surface opposite to the inner surface, the outer surface comprising a second flat portion and a second curved portion extending inward from a periphery of the second flat portion; and
a circumferential surface interconnecting the outer surface and the inner surface;
wherein a distance between the inner surface and the outer surface ranges from 0.2 mm to 1.0 mm, the first and the second curved portions are arcuate surfaces having radii of curvature ranging from 5 mm to 50 mm.

2. The glass housing of claim 1, wherein the first and the second curved portions have radii of curvature ranging from 5 mm to 20 mm.

3. The glass housing of claim 1, wherein the first and the second curved portions have radii of curvature ranging from 5 mm to 10 mm.

4. The glass housing of claim 1, wherein the inner surface is provided with a decorative layer formed by ink printing, the decorative layer has a thickness of 5 μm to 40 μm.

5. The glass housing of claim 1, wherein the inner surface is provided with a decorative layer formed by adhering a decorative film, the decorative film has a thickness of 10 μm to 125 μm.

6. The glass housing of claim 1, wherein at least one of the inner surface and the outer surface is provided with a surface compressive stress layer, the surface compressive stress layer has a thickness of 50 μm to 100 μm, the surface compressive stress layer has a compressive stress of 200 MPa to 300 MPa, a central tensional stress between the inner surface and the outer surface is less than or equal to 100 MPa.

7. The glass housing of claim 1, wherein the first and the second flat portions are shaped as a rectangle comprising two opposite long sides and two opposite short sides, radii of curvature of the first and the second curved portions connected to the long sides are equal to radii of curvature of the first and the second curved portions connected to the short sides.

8. The glass housing of claim 1, wherein the first and the second flat portions are shaped as a rectangle comprising two opposite long sides and two opposite short sides, radii of curvature of the first and the second curved portions connected to the long sides are not equal to radii of curvature of the first and the second curved portions connected to the short sides.

9. An electronic device, comprising a glass housing, wherein the glass housing comprises:
an inner surface comprising a first flat portion and a first curved portion extending inward from a periphery of the first flat portion;
an outer surface opposite to the inner surface, the outer surface comprising a second flat portion and a second curved portion extending inward from a periphery of the second flat portion; and
a circumferential surface interconnecting the outer surface and the inner surface;
wherein a distance between the inner surface and the outer surface ranges from 0.2 mm to 1.0 mm, the first and the second curved portions are arcuate surfaces having radii of curvature ranging from 5 mm to 50 mm.

10. A manufacturing apparatus for manufacturing a glass housing, comprising:
a chamber; and
an upper die and a lower die disposed in the chamber;
wherein the upper die comprises an upper flattened portion and an upper bent portion separated from the upper flattened portion, the lower die comprises a lower flattened portion and a lower bent portion separated from the lower flattened portion, the upper flattened portion and the lower flattened portion are configured to clamp a flat portion of a glass housing, the upper bent portion and the lower bent portion have the same arcuate curved surfaces, and the curved surfaces have radii of curvature ranging from 5 mm to 50 mm, the upper bent portion and the lower bent portion are configured to cooperatively extrude a curved portion of the glass housing.

11. The manufacturing apparatus of claim 10, wherein the upper bent portion comprises a plurality of upper bent sub-portions located around the upper flattened portion, the lower bent portion comprises a plurality of lower bent sub-portions located around the lower flattened portion; or the upper bent portion is shaped as a ring, the upper bent portion is disposed around the upper flattened portion, the lower bent portion is shaped as a ring, the lower bent portion is disposed around the lower flattened portion.

12. The manufacturing apparatus of claim 10, wherein at least one of the upper bent portion and the lower bent portion is provided with a heating source to heat the curved portion.

13. A method of manufacturing a glass housing, comprising:
cutting a glass mother substrate having a thickness of 0.2 mm to 1 mm into a plurality of glass sub-pieces with a predetermined dimension of the glass housing;
CNC processing the glass sub-piece to make the glass sub-piece have a required shape of the glass housing;
grinding the glass sub-piece to remove surface scratches and micro-cracks;
clamping and positioning a middle portion of the glass sub-piece, then extruding and bending a periphery of the glass sub-piece to form an arcuate curved surface, and the curved surface has a radius of curvature ranging from 5 mm to 50 mm; and
immersing the glass sub-piece into an alkali molten salt, thus forming a surface compressive stress layer on a surface of the glass sub-piece.

14. The method of claim 13, further comprising polishing the glass sub-piece prior to immersing the glass sub-piece into the alkali molten salt.

15. The method of claim 13, further comprising forming a decorative layer on a surface of the glass sub-piece after immersing the glass sub-piece into the alkali molten salt.

16. The method of claim 13, wherein during extruding and bending the periphery of the glass sub-piece to form the arcuate curved surface, the glass sub-piece is heated to a temperature of 690±10 ° C., the glass sub-piece is subjected to hot bending under a nitrogen atmosphere, the pressing pressure is 0.14±0.05 MPa, the pressing time is 2±0.5 min.

17. The method of claim 13, wherein during extruding and bending the periphery of the glass sub-piece to form the arcuate curved surface, the middle portion of the glass sub-piece is clamped without heating, the periphery of the glass sub-piece is extruded with heating.

18. The method of claim 13, wherein extruding and bending the periphery of the glass sub-piece to form the arcuate curved surface, the middle portion and the periphery of the glass sub-piece are heated simultaneously, and the periphery are extruded and bent.

19. The method of claim 13, wherein during immersing the glass sub-piece into the alkali molten salt, metal ions within a depth range of 50 μm to 100 μm from the surface of the glass sub-piece are exchanged with metal ions in the alkali molten salt to form a surface compressive stress layer, the surface compressive stress layer has a compressive stress of 200 MPa to 300 MPa.
